(19) United States
(12) Patent Application Publication
(10) Pub. No.: US 2009/0192931 A1
(43) Pub. Date: Jul. 30, 2009

(54) METHODS OF LIQUIDATING PHYSICAL, DOCUMENTARY & OTHER ASSETS

(76) Inventor: AHMAD AMIRI, RICHMOND HILL (CA)

Correspondence Address: AHMAD AMIRI, 21 DUNLOP ST., # 207, RICHMOND HILL, ON, L4C-2M6, CA

(21) Appl. No.: 12/334,151

(22) Filed: Dec. 12, 2008

Related U.S. Application Data
(60) Provisional application No. 61/024,438, filed on Jan. 29, 2008.
(60) Provisional application No. 61/024,500, filed on Jan. 29, 2008.

(51) Int. Cl. G06Q 40/00; G06Q 50/00

(52) U.S. Cl. 705/37

(57) ABSTRACT

Methods of enabling many, including the general public to convert their assets to stocks, such as common or preferred shares, bonds, warrants, etc., by providing an Entity which can accept assets in exchange for its stocks. Creating a market for said assets, for liquidating those without an efficient conventional market, especially after transferred to the entity is one adjunct to the methods. Providing a market for said stocks is another adjunct. Various other features to make the method appealing, acceptable to provides and users are introduced.

### PRIORITY CLAIMS

This Application claims priority of U.S. Provisional Application 61/024,438 filed Jan. 29, 2008 and 61/024,400 filed Jan. 29, 2008.

### PROBLEM

Some of the issues, applicable in various degrees to many Assets are that they are:
(a) not easily marketable or cashable, (b) not dividable to be sold, gifted or donated in fractions and must be sold in whole, even though a fraction of its value in cash may be needed.

Some examples of such physical Assets being:
land, buildings, houses, apartments, offices
aeroplanes, railcars, trucks, vans
time shares on real property, jet planes
arts, antiques, jewelry and the like
inventory
various other Assets

Broad Meaning of Terminologies:

Unless specifically mentioned, terminologies used here are not limiting the scope of the Invention, Application and/or Method. For example, AUR Terms are given here as illustrative examples and are not the only type of terms that can be employed. Other known and future versions can be adopted too.

Broader meaning of liquidating: Throughout this application, liquidating does not necessarily mean selling for cash but rather making easier to convert to cash, in whole or in part. For example when a house is exchanged for shares, Original Owner (OO) need not but can sell a fraction to all of those Stocks, yet enjoy appreciation of Entity Stocks she keeps, and even use the same house under a lease.

### PRIOR ART SOLUTIONS

A—Borrowing against an asset—provides some liquidity, but has serious disadvantages such as:
having to pay interest
not possible against many assets
having to repay the principal
costs and formalities of borrowing
reduction of privacy and credit rating

B—Securitizing very high value assets—such as a block of offices, some issues are:
only very large assets qualify
costs, time, complexity involved are enormous
compliance issues, even risk of jail for major owners and control persons

C—Opting for liquid assets—say shares of property funds instead of property, some problems being:
cannot be applied to assets one already owns
applicable only to a few types of assets
cannot be utilized, say a minor shareholder of a fund which owns an office block cannot use a fraction of said offices

Applicant's Method of Liquidating Assets—Major steps are:
setting up or providing an Entity (company, unit trust, partnership, fund, . . . ) to own assets
offering shares or units in the Entity in exchange for assets that Owners wish to liquidate
creating a market for Stock of said Entity, via a stock exchange or otherwise

Maintaining Utility for Original Owner (OO) or other designated persons, is possible by:
segregate asset utility rights (AUR), by way of a lease or similar instrument
assign said AUR to OOs if they wish to maintain use of the asset for some time

Elaborating the Method

Entity Fees: The Entity Management can generate revenue in a variety of ways, similar to Fund Managers.

But since one notion is to provide, not drain cash from OO, non cash fees may be preferred.

Management Preferred Stock, say equal to X percent of total Stock, or periodically selling some Stock are fees applied to the whole of the Entity. Other forms of Fees are possible, some examples are given.

Entity Management can charge a fee for each Asset, upon acquisition, preferably a percentage of Stock issued in return for said Asset. Thus different fees for different assets can be charged.

Also a percentage of proceeds of subsequent sale of Assets, as an incentive for good selling can be charged.

Fees may be applied to Management, Maintenance, Operating, Sale of Assets, etc.

Asset Buyback Provision: Can be used especially when an asset has sentimental value to Owner.

For example, the Entity agrees not to sell the Asset for a specified time, during or at the end of which, OO can buy it back at a pre-agreed price, a formula price, market price, etc. Such provisions may reduce the Stocks given to OO, and gives the Entity a potential buyer who may buy at a better price than others.

Segregating Asset Utility Rights (AUR)

AUR is a type of lease for use of an Asset, which can have following terms:
for a fixed period, for single life of OO, for joint life of OO and spouse, for perpetuity, for a term contingent upon an even, say until Asset sold by the Entity, etc
management and maintenance can be at User's cost or otherwise
AUR may be transferable
AUR may be prepaid or payable over its term or other arrangements
AUR buy back provision, which provision may be transferable, especially to last Owner of asset

AUR has a cost, which if utilized by the OO will be deducted from Asset Value, then Entity Stock allocated to OO for Asset Value less AUR cost.

Works of Arts & Jewelry AUR: An Owner may sell a painting to the Entity for Stocks, yet keep it. Maintenance costs are saved for both parties. A win win situation. OO can sell some Stock anyway.

Asset Maintenance & Management:

The Entity should provide Asset Maintenance, regardless of any income the asset my produce.

It should also provide Asset Operation for deriving income from its Assets.

The Entity can outsource all such activities to avoid being an operating company.

Maintenance Providers:

Can be created if not available at favorable terms or contracted to maintain Assets. They can also charge a flat fee to be deducted from Asset Value. If the fee is percentage of subsequent sale value, Maintenance Provider will have incentive for good maintenance. A percentage of Stock related to the Asset can also be given as fee. Other fee structures are possible.

Creating a Market for Entity Stock:

The Entity can take any legal form such as corporation, limited partnership, unit trust, investment fund, exchange traded fund, etc, which ownership is divided into shares, units, etc collectively called Stock here.

To maximize number of potential buyers for the Stock, the Entity can become an Reporting Issuer, allowed to Issue Stock to the Public. Further it can be Listed on an Exchange.

If costs, complexities and compliance of being a Reporting Issuer or being Listed are not warranted, the Stock can be Issued to and Traded between certain groups of people referred to as Accredited, Sophisticated, Affiliated, . . . or other subset of public Investors. Even this subset typically provides more liquidity for the Stock than liquidity of most underlying Assets. In this case, it can join a special type of Exchange often referred to as Private Placement Exchange or other names, that cater to Qualified Issuers, Buyers and Sellers of Stock. Exchanges can be Web Resident too.

Entity Stock Exchange (ESE):

ESE is an easy and effective means, for creating liquity for the Entity Stock, its Associates or Affiliates, which: (a) disclosure of information, (b) offering, (c) issuing, (d) trading, (e) other Stock related activities are limited to players who are legally eligible. If the Entity is a Reporting Issuer, most restrictions are removed.

ESE advantages include no need nor cost of listing on other exchanges, those who know of the Entity or check its website can be directed to ESE, at which point, unlike being listed on a general stock exchange, no other company is competing for share buyers, direct settlement of Stock transfers, etc.

ESE need not be in same jurisdiction as the Assets or the Entity, and may be in a more favorable one.

Other ways of providing a market for Entity Stocks, include but are not limited to distributing via:

(a) dealers buying and selling the Stock, (b) Entity Specific limited market dealers (c) investment bankers, (d) professionals, say accountants, lawyers, Realtors, (e) angle investor forums

Asset Maintenance Annuity (AMA):

Many assets have Maintenance which for the Entity, typically not a user of its acquired Assets, is a burden. Maintaining a land say, is generally not covered by its income. When the Entity acquires an Asset, its Value should be deducted to allow for future Maintenance until sold or becomes income producing.

AMA, introduced here, is one solution to cater for and quantify such burden. An Annuity Player, such as an insurer is paid a lump sum in exchange for a series of future payments for Maintaining the Asset. Said lump sum is deducted from Asset value to arrive at Net Asset Value.

AMA can have following and other features:
term can be fixed, for Asset's life, for single or joint life of User, contingent upon an event such as Asset being sold, etc
adjustment of future payments for general or asset related inflation
escalation of future payments for adjustment of quality to future standards
asset obsoleteness and replacement coverage
minimum sales value guarantees
credit insurance for receivables, income streams, life insurer default, etc
coverage for contingencies such as future tax and law changes
on going payment of all maintenance, asset related tax and insurance costs
repair, wear & tear warranties
redemption or buy-back clauses for earlier termination of AMA

AMA general use—AMA is a useful instrument, regardless of the Entity. For example, condominium developers or owners can purchase it and be secured of future tax, maintenance and insurance (TMI), protecting against TMI payment default by condo owners. AMA cost can be added to the Condo Price.

Banks can provide extra mortgages as borrowers are relieved of TMI and can afford higher mortgage.

Entity Specialization: Each type of assets should preferably be in a Specialized Entity. But Exchange listing of numerous entities may be costly, in which case each type better be in a Specialized Sub-Entity or Subsidiary, issuing “Tracking Stock” to OOs, which track the performance of each type of Assets.

Tax considerations may further justify such sub groupings. For example, residential homes tax advantages may be lost when converted to Stock, but may be saved if the home is in a Unit Trust and used by OO.

Potential Tax Benefits: Converting Assets to Stock may have tax advantages. Capital Gains Tax on Stock is usually lower than on the underlying Asset. Donating Stock of public companies to Charities has tax advantages above donating the Asset and is also easier for the charity to evaluate and liquidate.

Dividends: Entity can distribute dividends, from income, asset appreciation or capital distribution. But usually selling a fraction of Stock by Stockholders to get some cash is a better substitute than dividends.

Entity Borrowing Policy: There are merits in keeping the Entity loan free, as (a) no need for borrowing, (b) Entity assets will reflect its Stock value, (c) loans may force the Entity to sell assets prematurely.

But this may not always be possible, say when acquiring assets which are mortgaged to be paid off first.

Moving some assets to sub-entitie(s) which borrow and other assets to loan free sub-entities will provide clarity and improve loan to asset ratios.

Part Cash Payment for Assets: Paying cash to OO for part or all of the Assetted is an option, but:
it entails availability of cash which can prove difficult, especially at early years of Entity formation
it defeats the beauty of creating an Entity with lots of assets without raising much cash
cash better be spent on best assets, not just any asset offered, while one uniqueness of the Entity is the service of buying any asset, within some criteria, not necessarily the best assets
paying cash may require borrowing by the Entity, which has ramifications.

Asset Unitization: For substantial Assets, such as an office tower or a passenger jet, a specialized subsidiary can be created, which Units, rather than the Entity Stock are issued to OO, utilizing Entity's Expertise (Unitization, Operation, Marketing, Stock Liquidation, etc), yet Asset is not mixed with other assets.

Asset Operators: Can contracted or be created if not available at favorable terms, so that they can be sold optimally. Typically fees should be incentives for better performance, say percentage of profit or subsequent sales price.

Appraisal Methods: To trade an Asset for Entity Stock, the value of Stock is known, as it has a liquid market. Asset Valuation is often complex. Many methods exist. An approach introduced here is:
Original Owner sets a Claimed Value for the Asset
Asset is run through an Auction or Market, in which the OO can also bid and bring others bidders
preferably, right not to sell at even best Bid is preserved, so that Asset need not be sold
if the Best Bid is above Claimed Value, then OO is issued Stock for the Claimed value plus an agreed proportion, say half of the Best Bid excess over Claimed Value
if Best Bid is below Claimed Value, the OO is issued Stock at Best Bid less a multiple, say twice, the difference between Best Bid and Claimed Value.

Thus Claimed Value better be very conservative, below Market Value. Those who overstate the Claimed Value are penalized to the advantage of others. Less greed is rewarded directly by more Stock and indirectly by more valuable Asset injected into the Entity. If the same methodology is adopted consistently, even though all OO are forced to undervalue Assets given to Entity, for a debt free Entity, the Stock they own will have total value according to Market Value of Entity Assets (higher than total of Claimed Values). The Entity and OOs will indirectly share the penalties levied on those who overstate Claimed Values.

One Best Use of the Method: An old Owner sells her home to an Entity Stock which specializes in homes. She wishes to live in it for joint life of herself and spouse, hence maintains AUR for that period and opts for no buy back provision for the Entity, so that if the Entity sells the home, she cannot be evicted. She also opts for prepaid AUR and can have the maintenance costs borne by the Entity. Such arrangement gives her far less Stock than if she opted to pay for the AUR, agreed to vacate when the Entity so requires and maintains the home at her cost. Each year, she can sell a tiny fraction of the Stocks she got for her home, enjoy appreciation of unsold Stocks, which value is correlated with homes owned by the Entity.

Methods of Liquidating Documentary Assets

Some examples of Documentary Assets being:
intellectual property such as patents, copyrights, trademarks, customer lists, information
income streams, from royalties or other, may be discounted but conventionally not in fractions
life insurance, annuities, and similar assets, which are often not cashable, in whole or in part or there are penalties for surrendering or redeeming
airmiles, coupons (for discount, product or service supply)
barter credits or units, typically exchangeable for goods from a barter group members
receivables, which depend on credit of the debtor, disputes, etc
shares of companies which are not listed on a stock exchange
other assets

### PRIOR ART SOLUTIONS

A—Borrowing against an asset—provides some liquidity, but has serious disadvantages such as:
not possible against many assets
having to pay interest
having to repay the principal
costs and formalities of borrowing
reduction of privacy and credit rating

B—Securitizing very high value assets—such as a mature private company, some issues are:
generally only mature and large companies qualify
costs, time, complexity involved are enormous
compliance issues, even risk of jail for major owners and control persons

Applicant's Method of Liquidating Documentary Assets

One version of the solution broadly has the steps of:
setting up or providing an Entity (company, unit trust, partnership, fund, . . . ) to own assets
offering Stocks or Units in the Entity in exchange for Assets that Owners wish to liquidate
creating Liquidity for Stock of said Entity, via a stock exchange or otherwise

Anther version of the Solution is “Creating a Market for Assets without a conventional market”.

Also combining said two solutions, where Asset is transferred to the Entity for Stock, then the Entity uses existing markets or creates markets to boost its Asset values and liquidate them.

Creating Liquidity for Entity Stock:

The Entity can take any legal form such as corporation, limited partnership, unit trust, investment fund, exchange traded fund, etc, which ownership is divided into shares, units, etc collectively called Stock here.

To maximize number of potential buyers for the Stock, the Entity can become an offering entity to be allowed to issue Stock to the public. Further it can be listed on an Exchange.

If costs, complexities and compliance issues of being a reporting issuer or listed Entity are not warranted, the Stock can be issued to and traded between certain groups of people referred to as Accredited, Sophisticated, Affiliated, . . . or other subset of public Investors. Even this subset typically provides more liquidity for the Stock than most underlying Assets. In this case, it can join a Private Placement Exchange or similar Stock Market, that cater to said sublet of issuers, buyers and sellers of stock. Exchanges can be Web Resident too.

Entity Stock Exchange (ESE): ESE is an easy and effective means, for creating liquity for the Stock of the Entity, its Associates and/or Affiliates, in which: (a) disclosure of information, (b) offering, (c) issuing, (d) trading, (e) other Stock related activities are limited to those players who are legally eligible.

If the Entity is allowed to issue stock to public, most restrictions are removed.

ESE advantages include no need nor cost of listing on other exchanges, direct settlement of Stock trades, those who know of the Entity or check its website can be directed to ESE, at which point, unlike being listed on a general stock exchange, no competition with any other company looking for share buyers, etc.

ESE need not be in same jurisdiction as the Assets or the Entity, and may be in a more favorable one.

Other ways of providing a market for Entity Stocks, include but are not limited to: (a) via a number of dealers buying and selling the Stock, (b) via Entity Specific limited market dealers, (c) via investment bankers, (d) via angle investor forums, (e) via professional bodies

Entity Fees:

The Entity Management can generate revenue in a variety of ways, similar to Fund Managers.

But since one notion is to provide, not drain cash from OO, non cash fees may be preferred.

Having preferred Stock, say equal to X percent of total Stock, or periodically selling some Stock are fees applied to the whole of the Entity. Many forms of Fees are possible, some examples are given.

Entity Management can charge a fee for each Asset, upon acquisition, preferably a percentage of Stock issued in return for said Asset. Thus different fees for different assets can be charged.

Also a percentage of proceeds of subsequent sale of Assets, as an incentive for good selling can be charged.

Fees may be applied to Management, Maintenance, Operating, Sale of Assets, etc.

Entity Specialization: Each type of assets should preferably be in a Specialized Entity. But Exchange listing of numerous entities may be costly, in which case each type better be in a Specialized Sub-Entity or Subsidiary, issuing “Tracking Stock” to OOs, which track the performance of each type of Assets.

Tax considerations may further justify such sub groupings. For example, Receivables better not be mixed with Life Insurance, as Owners of one group of Assets may not appreciate mixtures.

Potential Tax Benefits: Converting Assets to Stock may have tax advantages. Capital Gains Tax on Stock is usually lower than on the underlying Asset.

Donating Stock of public companies to Charities has tax advantages above donating the Asset and is also easier for the charity to evaluate and liquidate.

Dividends: Entity can distribute dividends, from income, asset appreciation or capital distribution.

But to get some cash, an investor is usually better off selling a fraction of Stock.

Entity Borrowing Policy: There are merits in keeping the Entity loan free, as (a) no need for borrowing, (b) assets of debt free Entity reflect its Stock value, (c) loans may force the Entity to sell assets prematurely.

But this may not always be possible, say when acquiring assets which are mortgaged to be paid off first.

Moving some assets to some sub-entitie(s) which borrow and some assets to loan free sub-entitie(s) will provide clarity and improve loan to asset ratios.

Part Cash Payment for Assets:

Paying part or all of the Asset by cash, instead of Stock to OO is an option, but:
It entails availability of cash which can prove difficult, especially at early years of Entity formation
It defeats the beauty of creating an Entity with lots of assets without raising much cash
cash better be spent on best assets, not just any asset offered, while one uniqueness of the Entity is the service of buying any asset, within some criteria, not necessarily the best assets
paying cash may require borrowing by the Entity, which has ramifications.

Uniques Asset Unitization:

For substantial Assets, such as a major patent, a specialized sub-entity can be created, which Units, rather than the Entity's Stock are issued to Asset OO. Thus, all the Unitization, Operation, Marketing, Stock Liquidation and other expertise of the Entity Management is available to OO, but a unique Asset is not mixed with other assets.

Borrowing Secured by Entity Stock: It is often easier to borrow against liquid Entity Stocks than against underlying Assets, especially if Entity is Listed on a major stock exchange. This is another cash source.

### EXAMPLE

An old lady has life insurance, but needs some money now. Redeeming will cost her penalties and can only be done for all of the policy. Buying a favorable reduced policy is impossible due to her health.

She assigns the policy to an Entity specializing in Life Policies in exchange for Entity Stocks.

Selling part of the Stock provides her the needed cash, and remaining acts like a substitute policy.

Specialized Asset Markets:

This application introduces Markets for assets which conventionally have no market to exchange or sell them. These Markets are different from and in addition to Stock Exchanges for liquidating Entity Stocks. Entities as well as Owners and Buyers of Assets can use such markets.

Entities should create markets for their Assets, especially if they do not exist. Even if they exist, having an exclusive market has merits. Mechanics of creating a market, especially on-line or Internet one are known to the skilled. Examples of markets that do not exist yet, at least for pubic consumption follow.

Insurance Products Market: for Life Insurance, Annuities, etc., as a substitute for redeeming.

IP Market: for Know-how, Trade Marks, Copyrights, Proprietary Information, Customer Lists, etc.

Rights Market: for Agency, Distribution, Supply, Exclusivity or other Rights.

Barter Credit Market: Barter Credits, issued in return for prior goods or services supplied entitle the Owner to receive goods or services from a supplier or a group of suppliers.

For our purpose, Coupons for Discounts or Supply of goods or services and are similar to Barter Credits.

A Market can service a group or many groups of Issuers and/or Owners of Coupons or Barter Credits.

Airmiles Owners say can cash Airmiles in such market, facilitating purchase of sufficient airmiles for a trip.

Another version is exchanging one type of credit with another, say airmiles of air line A with those of B.

This is handy when the market is not fluid and selling one for cash to buy the other is not easy.

One group of buyers can be Coupon or Airmile Issuers who buy back their own obligations.

Pre-Sale Market: One use of this method is to generate cash by selling such credits, which may entail supply of one, few or any of supplier's products.

To enable more buyers to buy such Credits, the Supplier may guarantee to sell said supplies for the buyer.

Example is producer of a type of fridge can issue coupons for immediate or future delivery of fridges. Supplier can also guarantee, at a fee, to those who need it, to sell said fridges for the buyer when ready for delivery. Thus the Supplier raises cash selling typically future delivery promises. Buyer can delegate sales of the product to Supplier.

This way of raising cash is a cheap and feasible substitute for the costly, complicated often disallowed selling securities for which the supplier has no expertise.

Facilitating Tools, can assist operation, liquidity and popularity of Markets. Some examples are below.

Patent Market Services, paid by buyer and/or seller can lubricate Patent Markets:
Legal Investigators, to report on validity and strength of each patent
Market Researchers, to report on potential future market for a product or service
Technical Investigators, to check technical feasibility, if a concept works and at what cost
Fidelity Insurers, to insure any legal or title flaws in a patent, for example Applicant's misrepresentation which can someday invalidate a patent, but not visible until patent is ferenscly audited
Enforcement Costs Insurers

Patent Segmentation: Each patent can be divided into chunks by time period, say third to seventh year of issue, by region, say for use in New York State, by industry, say for Electronic Industry, other criteria and a combination of various criteria. Each segment can be sold separately.

A Different Patent Insurance: Conventionally, patent insurance covers an enterprises patent portfolio.

This application introduces Patent Specific Insurance (PSI) covering individual patents.

Insurers can advertise such coverage along with any sales material for the patent, say on the same website that offers a patent, preferably indicating the premium for cover and also link to other sites or pages for details, even enabling spot purchasing of cover.

PSI also indicates and monetarily quantifies how strong or risky a patent is, as judged by the Insurer.

Part Payment for Patent: To keep an Inventor or OO of a Patent interested in development of the subject of a Patent, only part of it can be exchanged for Stock. There can be a moratorium on selling the rest.

Insurances, to alleviate concerns about various players defaults in Credit, Performance, Fidelity, etc ease interplay between various parties.

Transfer Trustee: Sometimes, there are fees for transfer of ownership of Airmiles, Coupons or Credits. Transfers may even be prohibited. Transferring the Asset to a Transfer Trustee, officially or via a side agreement can often help, as multiple transfers to future buyers is only recorded by the Trustee, who owns it for the last owner and may issue a Custodian's Certificate to the last owner.

Standardizations, of forms, contracts, documents, etc can help in operating such markets.

Assignments, used when direct selling of an Asset is not allowed, say a life policy instrument is not transferable, but by law one can appoint an assignee.

Receivables Market:

Receivables are typically future obligation of a Debtor, payable to a Supplier or Creditor. Creditors can discount those receivables via Factors and banks, after cumbersome formalities of a line of credit.

There is no market where anyone can buy them as an investment.

Following tools are introduced here to facilitate a fluid market.

Credit Reporting Link: Credit and Rating Agencies to be linked to, selling and/or advertising their services on the Receivable Offering Site, so that a potential buyer of the Receivable can conveniently check Debtor's and any Guarantor's Rating.

Trustee Payee: Is a body to whom the payment is to be made, upon maturity, for onward payment to the last owner of a Receivable. Such a body can offer many receivable related services, so that a non professional Investor without any administrative means can invest in a Receivable. Once a Receivable is paid or even unpaid but insured, the Investor gets paid. Otherwise Trustee can, for a fee do collections and other steps.

Trustee information is most accurate on Payors financial health.

Creditor Confidentiality: Selling Receivables is sometimes perceived as Creditor's inability to wait.

Trustee Payee can hide any sale of Receivable.

Lien Agents: Hold liens on Debtors assets, for benefit of Creditors.

Debt Authenticators: A body, independent of Creditor and Debtor, that receives and records, physically and/or digitally, Debtor's Acknowledgement of Debt, if requested by Creditor, as proof.

Receivable Specific Insurance (RSI): Conventionally, a Creditor can only insure its receivables portfolio, not an individual receivable. RSI is to Insure a Receivable, purchased by the Creditor or even Debtor who wants to make its payment promises more attractive to Creditors, to increase its credit limits.

Debtor can also buy a Master Credit Insurance, covering some or all of its Payables.

RSI can be offered along with or via the same page, site and/or market via which the Receivable is sold.

Even the premium can be announced, say “We insure this receivable for $Y”

Insurance can also be offered and priced on Debtor or Creditor who sells Receivable with Recourse.

Example ad: “We, insure this Debtor's Payables for up to $Z for $P/1000”.

Dispute Insurance: Offered to Creditor or Receivable Buyers. They can cover portfolio of Debtors, Creditor or Receivable Buyer. Preferably should be Receivable Specific to ease trading of each Receivable.

Fidelity Insurance: Cover misrepresentations and fraud. In other respects similar to Dispute Insurance.

Uniform Debt Instrument (UDI): Issued by Debtor, providing Debtors details, amount, payment due dates, if disputes are waived, interest on delayed payment, discount on early payment, etc.

UDI can preferably have signed instructions to the bank for payment, upon presentation by and to the account instructed by last holder of UDI.

UDI can be signed also by any Guarantor (such as those who sell it in the Market, Insurers, etc).

Debtors have reason to make their Payables marketable and attractive to Creditors and Assignees.

One type of UDI can be issued by a Creditor, claiming a Receivable. Then its value will depend on whether signed by Debtor, its RSIs, Recourse to Creditor, etc.

### EXAMPLE

A Supplier can only close the sale to a major Chain if agrees to their three months terms, knowing that Debtor will practically not pay for five months. It will be detrimental to give a discount for earlier payment, which will reveal existence of a large profit margin, tempting the Chain to press for a lower price anyway. Supplier agrees, provided the Chain agrees to payment to a Trustee Payee and informs the Chain that the Trustee cannot be instructed to wait beyond terms. The Chain either admits that payment may be delayed, in which case has to pay a higher price, or agree to pay the Trustee. Supplier then exchanges the Receivable for the Stock of an Entity specializing in Receivables. Values the Receivable at Face Value less Term Discounts, Trustee Payee fees, Premium to Insure the Chain's Credit, Entity fees, etc. Supplier sells part of the Stock, and keeps the rest, to receive dividends and capital appreciations generated buy the Entity waiting to maturity of all such Receivables bought at a discount. The Entity sells some of its Receivables before maturity, in a Receivables Market. The Chain decides to buy back its own Payable, which costs less than borrowing from the bank to buy it.

### EXAMPLE

An Inventor has a Patent, but little means of marketing to license it, let alone commercializing it. She needs some money to make prototypes for presentation to licensees. Selling it all at concept stage is underselling. She offers 20% of her Rights for 5 years in California to an Entity which not only specializes in Patents, but has subsidiaries focusing on her type of patents.

To Appraise the Patent, the Entity Auctions it the Entity's own Patent Market. She pays for Technical and Legal scrutiny before auctioning. As the Best Bid is dismal, below and a least price she sets, it is not sold. Based on Best Bid, the Entity Issues her Tracking Stock for Entity Subsidiary, which she sells in a Private Equity Stock Market in which Entity's Tacking Stocks are traded. She uses the money for prototypes. Now she has a “developed invention” plus visibility due to the auction plus visibility due to the Entity being a resource for patent buyers, hence at least three levels higher than at concept patent. Repeating the steps for the next 20% generates more money, so that she can commercialize it, and so on.

Liquidating Businesses:

Methods of this Application can be adopted to Stakes in Private Companies, Limited Partnerships, etc.

Value of such Assets depends on Owners/Directors Performance. Therefore the Entity cannot offer the OOs Stocks and let them cash out and dump the Business. OOs should have continued incentive to run the Business long after it is transferred to the Entity. It is too costly, often not worth while, even impossible for the Entity to operate numerous Businesses. Example Solution:
Original Owners can transfer, say less than half of voting stock of the Business, so that they remain in charge, responsible, balmable and interested in management
A large proportion of non-voting stock of the Business should also remain with OOs as incentive
OOs only receive BusinessTracking Stocks (BTS), which simulate their Business performance
Only a fraction of BTS can be exchanged for Entity Stock each year, free to be sold
Entity Stocks issued for said BTS is based on BTS Valuation Methods
One Valuation Methods is that paid in Virtual Markets in which BTS are hypothetically traded
Such Valuations better be averaged or mathematically smoothed over some period to ease fluctuations

Virtual Markets:

There are a number of them operated on the Internet. They use Virtual Money, usually but not necessarily bought for real money by numerous market participants, who buy and sell virtual stocks. Existing or created Virtual Markets can be used to price many things based on market mechanisms, and provide a good approximation to reality. One example is Second Life, which is home to an alter ego to many corporations.

Actual Markets: Where legally allowed, say when Investors are Accredited, Sophisticated, Affiliated, Business Socks or Securities can be Issued and Traded on an Existing or Created Stock Exchange.

Business Stock Values in such Exchanges can determine the number of Entity Stock received by Owners.

Tools introduced for Virtual & Actual Markets: Business Original Owners can and/or may be required to use many tools to mimic or substitute transparency, fidelity, confidence and other means of major stock exchanges. Such tools, typically but not necessarily paid for by the benefiting Business, include:
Business Website, linked to Market Website, including Biz Plans, Investors Page+Q&A+FAQ
Updated Information Template, on line, to be answered, not answered with or without reason
Off Template Info
Reports, typically paid by the Business and/or Inventors by Directors, Investors, Auditors, Asset Appraisors, Unions, Market Players, Business Valuators, Insurers, Employees, Media, BBB, Police, Relevant Government Agencies s.a. EPA, Banks, Entity, BTS Market, Lawyers, Related Associations, Credit Rating Agencies, Investigators checking Business and Directors claims, Market Researchers for Business Products or Services, Consumer Associations, . . . to be posted on Business and/or Site
Market Players, such as Investors, Brokers, Dealers, Market Makers, Underwrites, Investment Bankers, Analysts, Investment Rating Agencies, Share Transfer Agents, Regulators, . . . to be established
Weblogs, Forums, News groups, etc discussing the Business by many and many concerned factions
Investor Protection Insurance, for Fidelity, Fraud, Compliance, Enforcement, etc
Market's and/or Entities Collective Enforcement of Rules, as an SEC type Regulator for BTS
Speculation Tax, say 3% of each Trade charged by the Entity, to slow irratic trades and price swings
Educational & Investment material by the Market, Entity, BTS
Standard Agreements, especially between Business & even if Virtual Investors
Black listing and Flagging of the wrong doers

Clarifications:

Original Owner as Operator—We discussed Asset Operators as contractor who operate a number of entity assets. There is no reason why the Original Owner is not chosen as the Asset Operator, at least for a specified time. Familiarity with, desire to use, better care for the asset, etc are some of the rationale. Operator can receive money, stocks, etc.

Entity Need Not Manage Assets: It is possible that Management of the Assets remains with OO or delegated to a third party. One example is a Condo Owner transferring to the Entity, but Management remains with Condo Corp.

Broad Meaning of Original Owner—OO is to be regarded as the legal or real person who Transfers the Asset to the Entity, hence can be called Transferor and may not have Ownership, but Custody, Trustee or other Roles.

Private Mortgages: They are in fact Secured Receivables and as such can be Transferred, even by individual owners to an Entity for Stakes in said Entity. Owners need not be affiliated or one big owner, but many unrelated owners.

Various Types of Entity Securities: Entity and or its affiliates need not only Issue Common Shares, but can Issue Preferred Shares, Bonds, Rights, Warrants, etc in exchange for the Assets. One important form is issuing Voting Shares to its Founders, Cash Investors, Certain Investors, Management, etc, but Non-Voting Shares to Asset Transferors or OOs, so that the Directors need not change as OOs become new Shareholders. One good legal form for the Entity is Limited Partnership, where OOs become Limited Partners, but the Decision makers are General Partners or Directors and Shareholders of the General/Managing Partner.

Affiliated Entities: It is possible to inject the asset into an Entity Affiliate, the OO receives Securities in the Entity or Affiliate or Both. In particular, Entity can have various Subsidiaries, each specializing in a number of Assets. OO receives securities in the Sub to which the Asset was transferred or in the Entity or both. Also that Entity and Sub Securities can be exchangeable by prior agreement. This means Core Entity Management but Securities Track Different Assets. Those transferring or interested in Works of Arts receive Tracking Securities for the Arts Sub, while those interested in Real Estate receive Securities in another Sub.

Generalizations: Concepts introduced here can be modified in numerous ways.

### SUMMARY OF SOME OF THE METHODS

1—A method of facilitating management and liquidating an asset comprising the steps of:
providing a legal entity which can own assets,
authorizing said entity to issue securities in exchange for assets,
transferring said asset to said entity in exchange for a said securities,
said securities to be a major part of the consideration paid for said asset,
providing a market to facilitate liquidating and trading said securities,
promoting said facility as a routine business for the entity, different from incidental asset for stake transactions,
extending said facility also to assets securitizing which without aggregating with other assets is unviable,
extending said facility also to a transferor who before said transfer, is unrelated to the entity,
extending said facility also to a transferor who after said transfer, will be unrelated to the entity, and
extending said facility also to a number of transferors who are unrelated to each other,

where one party is considered related to another if one controls the other, is controlled by the other or controlled by those controlling the other.

2—Method 1 where:
the asset's utility rights, for a certain time, under certain conditions, are segregated as a separate asset, and
said segregated asset utility rights are arranged to be at transferor's discretion.

3—Method 1 where transferor is provided with the right to reacquire the asset under certain terms.

4—Method 1 where a market is provided for those underlying assets for which existing markets are inadequate.

5—Method 1 where a dedicated exchange is provided for various stocks issued by the entity and by its affiliates.

6—Method 1 where said assets are barter credits.

7—Method 1 where said assets are intellectual property with Means to facilitate its operation. Said Means are referred to in this specification as Patent Market Services, Patent Segmentation & Patent Specific Insurances. Also Insurances, Transfer Trustee, Standardization & Assignments, etc.

8—Method 1 where said assets are suppliers coupons.

9—Method 1 where said assets are airmiles.

10—Method 1 where said assets are receivables.

11—Method 1 where said assets are receivables and a number of Means for facilitating its operation are provided. Said Means are referred to in this Specification as Credit Reporting Link, Receivable Specific Insurance, Dispute Insurance, Uniform Debt Instrument, Debt Authenticators, Trustee Payee, Lien Agents, Fidelity Insurance, etc.

12—Method 1 where said assets are each a stake in a business.

13—Method 1 where said assets are each a stake in a business and a number of Means for facilitating a market in such businesses are provided. Said Means are referred to in this Specification as Tools introduced for Virtual & Actual Markets.

14—Method 1 where said assets are each a stake in a business and a number of Means for facilitating a market in such businesses are provided where said Means are tools for virtual and actual markets.

15—Method 1 where said entity issues different securities, each tracking the performance of one type of its assets.

16—Method 1 where it only acquires assets on which there are no liens.

17—Method 1 where all assets on which liens are placed are transferred to an affiliated entity, such that the entity itself is lien free, and foreclosures of said liens does not affect assets not owned by said affiliate.

18—Method 1 where a number of Means to facilitate its operation are provided. Said Means are referred to here as Asset Maintenance Annuity, Appraisal Methods, Asset Utility Rights (AUR), Segregating AUR from the Asset. Also Maintenance Providers, Entity Specialization, Entity Borrowing Policy, Part Cash Payment for Assets, Asset Operators, Asset Unitizations, Asset Buy Back Provision, etc.

19—Method 1 where the management and maintenance of some of said assets is delegated to its transferor.

20—Method 1 where said Assets are Works of Arts & Jewelry.

1- A method of facilitating management and liquidating an asset comprising the steps of:
providing a legal entity which can own assets,
authorizing said entity to issue securities in exchange for assets,
transferring said asset to said entity in exchange for a said securities,
said securities to be a major part of the consideration paid for said asset,
providing a market to facilitate liquidating and trading said securities,
promoting said facility as a routine business for the entity, different from incidental asset for stake transactions,
extending said facility also to assets securitizing which without aggregating with other assets is unviable,
extending said facility also to a transferor who before said transfer, is unrelated to the entity,
extending said facility also to a transferor who after said transfer, will be unrelated to the entity, and
extending said facility also to a number of transferors who are unrelated to each other,
one party is considered related to another if one controls the other, is controlled by the other or controlled by those controlling the other.

2- Claim 1 where:
the asset's utility rights, for a certain time, under certain conditions, are segregated as a separate asset, and
said segregated asset utility rights are arranged to be at transferor's discretion.

3- Claim 1 where transferor is provided with the right to reacquire the asset under certain terms.

4- Claim 1 where a market is provided for those underlying assets for which existing markets are inadequate.

5- Claim 1 where a dedicated exchange is provided for various stocks issued by the entity and by its affiliates.

6- Claim 1 where said assets are barter credits.

7- Claim 1 where said assets are intellectual property with means to facilitate its operation.

8- Claim 1 where said assets are suppliers coupons.

9- Claim 1 where said assets are airmiles.

10- Claim 1 where said assets are receivables.

11- Claim 1 where said assets are receivables and a number of means for facilitating its operation are provided.

12- Claim 1 where said assets are each a stake in a business.

13- Claim 1 where said assets are each a stake in a business and a number of means for facilitating a market in such businesses are provided.

14- Claim 1 where said assets are each a stake in a business and a number of means for facilitating a market in such businesses are provided where said means are tools for virtual and actual markets.

15- Claim 1 where said entity issues different securities, each tracking the performance of one type of its assets.

16- Claim 1 where it only acquires assets on which there are no liens.

17- Claim 1 where all assets on which liens are placed are transferred to an affiliated entity, such that the entity itself is lien free, and foreclosures of said liens does not affect assets not owned by said affiliate.

18- Claim 1 where means to facilitate its operation are provided.

19- Claim 1 where the management and maintenance of some of said assets is delegated to its transferor.

20- Claim 1 where said assets are works of art and jewelry.
